(19) United States
(12) Patent Application Publication
(10) Pub. No.: US 2025/0259505 A1
(43) Pub. Date: Aug. 14, 2025

(54) ALLOWING OPERATOR AND REGULATORS THE ABILITY TO INFLUENCE ARTIFICIAL INTELLIGNECE (AI) GENERATED CONTENT

(71) Applicant: IGT, Las Vegas, NV (US)

(72) Inventors: Dwayne Nelson, Las Vegas, NV (US); Bryan Wolf, Reno, NV (US)

(21) Appl. No.: 18/440,145

(22) Filed: Feb. 13, 2024

(51) Int. Cl. G07F 17/32

(52) U.S. Cl. CPC G07F 17/3227; G07F 17/3223; G07F 17/3237; G07F 17/3255

(57) ABSTRACT

Embodiment of the present disclosure are directed to using generative Artificial Intelligence (AI) to generate content for use in an electronic game based on a set of prompts. The prompts can include an initial prompt defining the content. One or more additional prompts can be used to defined conditions or restrictions on the content that may be generated. These additional prompts can be combined with the original prompt to form a final prompt to be provided to the generative AI. For example, the additional prompts can include one or more prompts from an operator of a gaming venue in which a gaming system on this the electronic game will be executed is installed. Additionally, or alternatively, the additional prompts can include one or more prompts from a regulatory agency for a geographic region of the gaming venue.

### BACKGROUND

The present disclosure is generally directed to generating content for use in an electronic game and more particularly to generating content for use in an electronic game using generative artificial intelligence and based on a set of prompts defining the content and placing additional conditions on the content that may be used.

### BRIEF SUMMARY

Embodiment of the present disclosure are directed to using generative Artificial Intelligence (AI) to generate content for use in an electronic game based on a set of prompts. The prompts can include an initial prompt defining the content. One or more additional prompts can be used to defined conditions or restrictions on the content that may be generated. These additional prompts can be combined with the original prompt to form a final prompt to be provided to the generative AI. For example, the additional prompts can include one or more prompts from an operator of a gaming venue in which a gaming system on this the electronic game will be executed is installed. Additionally, or alternatively, the additional prompts can include one or more prompts from a regulatory agency for a geographic region of the gaming venue.

According to one embodiment, a method for generating content for an electronic game can comprise generating a first prompt describing content for the electronic game. In some cases, the first prompt can be generated based on information about a player of the electronic game. Additionally, or alternatively, the first prompt can be generated based on a set of options defined by an operator of a gaming venue in which the electronic game is installed. The set of options can identify electronic games to which the first prompt can be applied, game elements of the electronic game to which the first prompt can be applied, a time during which the first prompt can be applied to the electronic game, types of electronic games to which the first prompt can be applied, players for which the first prompt can be applied, and/or conditional logic for applying the first prompt.

A second prompt describing additional conditions for the content for the electronic game can be received. A third prompt can be generated comprising a combination of the first prompt and the second prompt. The third prompt can be provided to a generative Artificial Intelligence (AI) system and the content for the electronic game can be received from the generative AI system. The received content for the electronic game can then be applied to the electronic game.

According to another embodiment, a gaming system can comprise a processor coupled with the communications interface and the input device. A memory can be coupled with and readable by the processor and can store therein a set of instructions which, when executed by the processor, causes the processor to generate a first prompt describing content for the electronic game and receive a second prompt describing additional conditions for the content for the electronic game. The second prompt can be received, for example, from an operator of a gaming venue in which the gaming system is installed. The additional conditions described by the second prompt can enforce a brand image for the gaming venue, promote a service of the gaming venue, relate to a player loyalty program for the gaming venue, relate to seasonal content for the electronic game, etc.

A third prompt can be generated comprising a combination of the first prompt and the second prompt. The third prompt can be provided to a generative Artificial Intelligence (AI) system and the content for the electronic game can be received from the generative AI system. The received content for the electronic game can then be applied to the electronic game.

According to yet another embodiment, a gaming venue host system can comprise a processor and a memory coupled with and readable by the processor. The memory can store therein a set of instructions which, when executed by the processor, causes the processor to generate a first prompt describing content for an electronic game executed by a gaming system and receive a second prompt describing additional conditions for the content for the electronic game. The second prompt can be provided by a gaming regulator of a geographic area of a gaming venue in which the gaming system is installed. The additional conditions for the content for the electronic game described by the second prompt can relate to enforcing gaming regulations, avoiding player confusion, avoiding use of content pre-defined as being prohibited, etc.

A third prompt can be generated comprising a combination of the first prompt and the second prompt. The third prompt can be provided to a generative Artificial Intelligence (AI) system and the content for the electronic game can be received from the generative AI system. The received content for the electronic game can then be applied to the electronic game.

Additional features and advantages are described herein and will be apparent from the following Description and the figures.

### BRIEF DESCRIPTION OF THE SEVERAL VIEWS OF THE DRAWINGS

FIG. 1 is a block diagram illustrating an exemplary environment in which embodiments of the present disclosure can be implemented.

FIGS. 2A-2C are block diagrams conceptually illustrating using a set of prompts to generate content for an electronic game according to embodiments of the present disclosure.

FIG. 3 is a block diagram illustrating content of an exemplary prompt data file according to one embodiment of the present disclosure.

FIG. 4 is a block diagram illustrating additional details of components of an exemplary gaming system according to one embodiment of the present disclosure.

FIG. 5 is a block diagram illustrating additional details of components of an exemplary gaming venue host system according to one embodiment of the present disclosure.

FIG. 6 is a flowchart illustrating an exemplary process for generating content for an electronic game according to one embodiment of the present disclosure.

### DETAILED DESCRIPTION

Embodiment of the present disclosure are directed to using generative Artificial Intelligence (AI) to generate content for use in an electronic game based on a set of prompts. The prompts can include an initial prompt defining the content. One or more additional prompts can be used to defined conditions or restrictions on the content that may be generated. These additional prompts can be combined with the original prompt to form a final prompt to be provided to the generative AI. For example, the additional prompts can include one or more prompts from an operator of a gaming venue in which a gaming system on this the electronic game will be executed is installed. Additionally, or alternatively, the additional prompts can include one or more prompts from a regulatory agency for a geographic region of the gaming venue.

For example, the content can be for an electronic game played on an Electronic Gaming Machine (EGM), video lottery terminal (VLT), kiosk, web browser, mobile phone or virtual reality device. The generative AI prompts can be augmented with prompt text from the operator or regulator. This allows the operator or regulator to put guard rails on the generative AI. For example, the regulator might restrict the generated content to not have any copyrighted material, not contain content for children or not have content that is illegal. The operator may request that the generated content not contain logos of competitors or request that the content contain images that are consistent with the casino property theme.

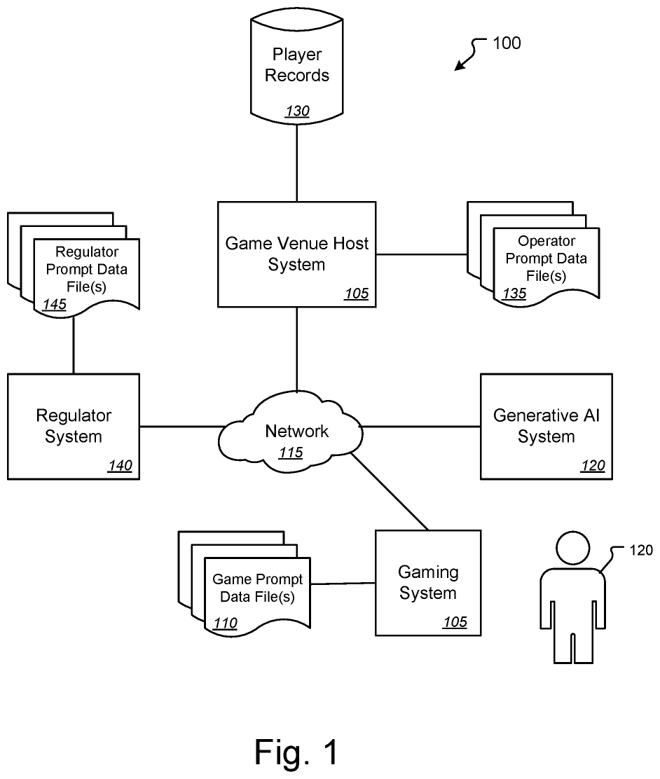

FIG. 1 is a block diagram illustrating an exemplary environment in which embodiments of the present disclosure can be implemented. As illustrated in this example, the environment 100 can include a gaming system 105. The gaming system can comprise, but is not limited to, an EGM, VLT, kiosk, web browser, mobile phone, virtual reality device, or any other device capable of executing an electronic game. Such a game can include, but is not limited to, slots, video slots, video poker, keno, blackjack, etc. to be played by a player 120, e.g., in a casino or other gaming venue.

The gaming system 105 can be coupled with a communications network 115. The communications network can comprise any one or more wired and/or local-area and/or wide-area networks as known in the art including, but not limited to, the Internet. Also coupled with the communications network 115 can be a generative AI system 120, a gaming venue host system 125 for a casino or other gaming venue in which the gaming system 105 is installed, and a regulator system 140 of a regulatory authority for a geographic region of the casino or gaming venue in which the gaming system 105 is installed. Each of the generative AI system 120, gaming venue host system 125 and regulator system 140 can comprise any one or more servers and/or other computing devices as known in the art.

Generally speaking, generative AI as may be provided by generative AI system 120 is a type of AI that can generate pictures, movies, text, language, sounds, and/or other content based on prompts. DALL-E is an example generative AI website and application that generates images based on input prompts. Midjourney is another popular generative AI application for images. A user of such systems can provide a prompt and the generative AI can provide one or more images or other content based on the prompts. The prompt can be human readable text that describes, in human language, the type of content the user wants. For example, the user could provide the prompt “a picture of a cute cat” or “a cartoon of a cute cat eating a fish”. This is the current state of art for generative AI. Prompts could also be in other formats such as binary, XML, json or other format that can provide the information desired.

In some cases, generative AI can be used to generate content to be utilized within an electronic game. In a gaming context, it should be clear that the AI generated content can include, but is not limited to, slot symbols, background images or scenes, pay lines, button panels, sounds, animations, card backs, card faces, bingo cards, keno cards, icons, avatars or characters, shaders, borders, titles, frames, win celebrations, player prompts or message, and/or other content. In some cases, generative AI could be used for custom messages or to translate messages, e.g., “Provide a congratulatory message in French.”

According to one embodiment, the gaming system 105 can provide prompts, i.e., game prompts, to the generative AI system 120 in order to create content for a player 120. In some cases, the game prompts may additionally, or alternatively, be provided by the gaming venue host system 125. The gaming system 105 or gaming venue host system 125 could create content for an individual player 120 or for a group of players, e.g., such as for all high rollers. The gaming system 105 and/or gaming venue host system 125 could request the content from the generative AI system 120 using a set of prompt data as will be described herein. In some embodiments, the generative AI system 120 can be a third-party system or service accessible via the Internet while in other embodiments the generative AI system 120 can be on a closed, local network 115 accessible to the gaming system 105 and/or gaming venue host system 125 or multiple casino or other gaming venue systems.

According to one embodiment, the gaming system 105 and/or gaming venue host system 125 can use player information from a set of player records 130 to generate one or more prompts to be provided to the generative AI system 120. For example, is the player 120 likes Egyptian themes, the gaming system 105 or gaming venue host system 125 can create one or more prompts such as “Picture of a classic Egyptian scene” or “Picture of a pyramid” based on a set of game prompt data files 110. According to one embodiment, these game prompts can then be augmented by the gaming venue host system 125 to add a set of operator prompts based on a set of operator prompt data files 135. As will be described below, the operator prompts can place additional restrictions on the content generated. Additionally, or alternatively, the game prompts can be augmented with a set of regulator prompts provided by the regulator system 140 based on a set of regulator prompt data files. The regulator prompts can also provide additional conditions or restrictions on the generated content as will be describe.

The gaming system 105 and/or gaming venue host system 125 can store the prompt(s) with one or more options. The options might indicate how to use the prompt(s) such as use a particular prompt for new games. The options might be one or more of: limit the prompt to new games; to which game element to apply the prompt such as slot symbol, icon, player cards, payline, button panel, text displayed to player, win animation, win sound, etc.; a certain time limit or time window; limit the prompt to certain game types; limit the prompts to certain players, e.g., new players, high rollers, suspected cheaters, etc.; conditional logic such as apply the prompt to loyalty club member or those who ARENT loyalty club members, apply the prompt to new players, apply the prompt on certain game events or for a timed time, etc.

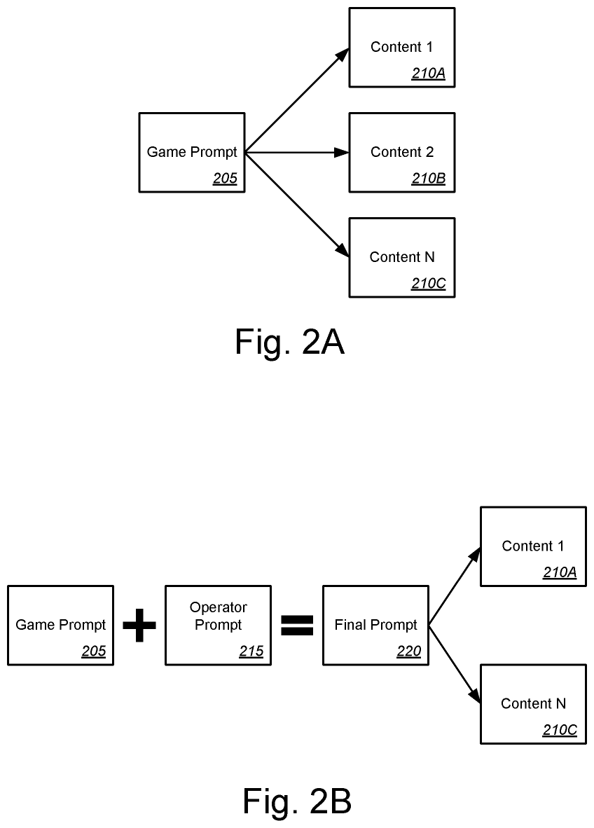

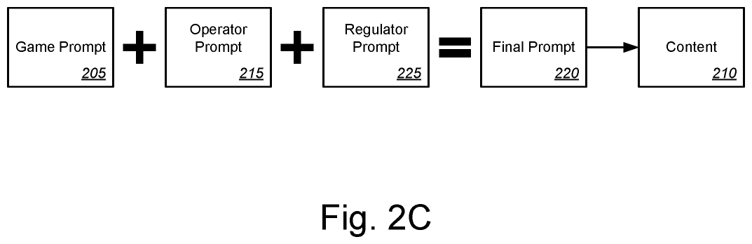

FIG. 2A-2C are block diagrams conceptually illustrating using a set of prompts to generate content for an electronic game according to embodiments of the present disclosure.

More specifically, FIG. 2A shows a game prompt 205 as may be generated by a gaming system 105 or gaming venue host system 125 that wishes to use generative AI to generate a slot symbol. The system can use a prompt such as “Picture of a pyramid.” Three results 210A-210C are shown that could be used as content for the electronic game that were provided by the generative AI system 120.

According to one embodiment, the operator can also provide prompt information. FIG. 2B illustrates addition of operator prompt 215 information. For example, the gaming system 105 can provide the game prompt 205 “picture of a pyramid” and combine that with the operator prompt 215 “without images of my competitors” to generate a final prompt 220 used to generate content 210 A and 210B. This results in a data set that DOES NOT include the image of the Luxor Casino in Las Vegas because the operator competes with the Luxor. The operator prompt 215 might include prompt text that: enforces the brand image of the casino, e.g., the theme of the casino, the color theme of the casino, the style of the casino, etc.; contains information or promotions about casino services such as a restaurant, bar, spa, shows, etc.; rewards loyalty club players; encourage players to become loyalty club players; encourage players to use casino services; provide seasonal content such as holiday, events, shows, etc.

Additionally, or alternatively, the gaming system 105 or gaming venue host system 125 might include a regulator prompt in addition to, or instead of, the operator prompt 215. FIG. 2C shows how the system combines the game prompt 205 with the operator prompt 215 and regulator prompt 220 into a final prompt 220 used to generate content 210. For example, if the regulator does not want any content that advertises to children, the regulator prompt 225 can be “without images catering to children.” The regulator might include prompt text that: ensures regulations are met; avoids confusion by the player; avoids the use of illegal or unlicensed content; avoids the use of explicit image or language; etc. For example, the regulator prompt 225 might add “without violating the gaming regulations of Nevada.”

The gaming system 105 and/or gaming venue host system 125 might have a language engine to concatenate or otherwise properly combine the prompts. For example, in the above example the regulator could enter “without images catering to children” and the system could automatically and the “and” to the prompt text to form a proper sentence.

In one embodiment, the gaming venue host system 125 can prevent a game theme from playing if there is no configured operator and/or regulator prompt. In this embodiment, the gaming venue host system 125 can learn that a game theme uses generative AI. It could learn this using a network protocol or through some data files that describe each game theme. When the gaming venue host system 125 detects that the theme requires generative AI, the gaming venue host system 125 could disable the theme or prevent the installation of the theme until the operator and/or regulator prompt configurations are provided. In one embodiment, the requirement for the regulator to provide content could be made per market such that in some jurisdictions the regulator prompt configuration is required while in others it is not. This determination could be made by the gaming system 105 or the gaming venue host system 125.

In one embodiment, when a new theme is installed onto a gaming system 105, the operator and regulator prompt configurations can be automatically applied to the new theme. This works well for the scenario where the operator prompts aren't specific to a game theme and therefore can be applied to any game theme. However, in some embodiments the generative AI requirements of the theme maybe not allow for the generic operation/regulator prompt configurations to be used. For example, a theme might have custom celebrity voice overlays created by the generative AI system 120 and the existing operator and regulator prompt configurations do not cover this scenario (audio voice overs).

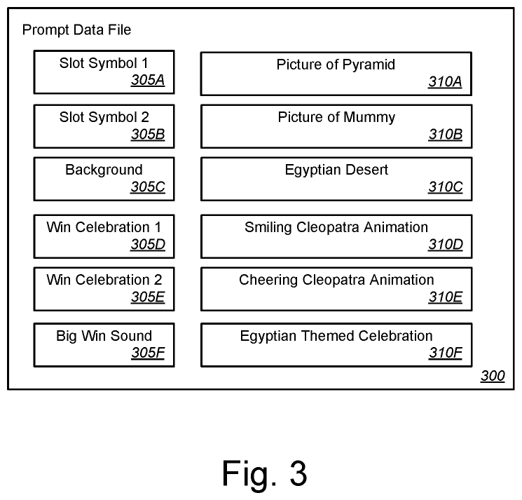

In one embodiment, the game prompt 205 is a file or database. The file can contain various elements and the associated prompts to use. FIG. 3 is a block diagram illustrating content of an exemplary prompt data file according to one embodiment of the present disclosure.

The file 300 can comprise a list a categories 305A-305F, such as slot symbol 1, etc., and then a list the prompt(s) 310A-310F to use for each category. In the example, there is a single prompt per category, but the file 300 could allow for multiple prompts that are random used or conditionally used based on other data.

In one embodiment, the prompt data can list, in addition to the prompt text, the formatting requirements. For example, the slot symbols might be 512×512 pixels and the background image could be a 4:3 image ratio. The formatting requirements could include color depth, format, frequency, video encoding parameters, sound volumes, brightness, color parameters, etc.

In one embodiment, the gaming venue host system 125 can maintain the prompt data file 300. The gaming venue host system 125 could have a database of which prompt data file to use for which themes. This allows for the gaming venue host system 125 to adjust prompt data without updating the game package which is a big advantage since game packages may require regulatory approval and review.

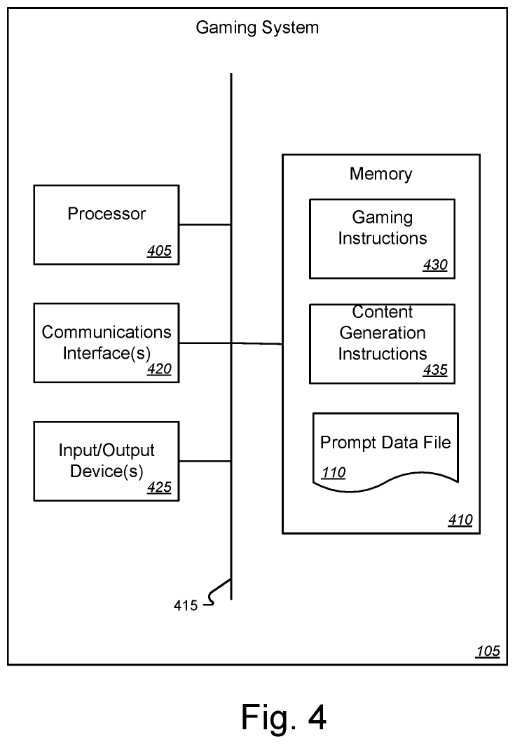

FIG. 4 is a block diagram illustrating additional details of components of an exemplary gaming system according to one embodiment of the present disclosure. As illustrated in this example, a gaming system 105 such as described above can comprise a processor 405. The processor 405 may correspond to one or many computer processing devices. For instance, the processor 405 may be provided as silicon, as a Field Programmable Gate Array (FPGA), an Application-Specific Integrated Circuit (ASIC), any other type of Integrated Circuit (IC) chip, a collection of IC chips, or the like. As a more specific example, the processor 405 may be provided as a microprocessor, Central Processing Unit (CPU), or plurality of microprocessors that are configured to execute the instructions sets stored in a memory 410. Upon executing the instruction sets stored in memory 410, the processor 405 enables various functions of the gaming system 105 as described herein.

The memory 410 can be coupled with and readable by the processor 405 via a communications bus 415. The memory 410 may include any type of computer memory device or collection of computer memory devices. Non-limiting examples of memory 410 include Random Access Memory (RAM), Read Only Memory (ROM), flash memory, Electronically-Erasable Programmable ROM (EEPROM), Dynamic RAM (DRAM), etc. The memory 410 may be configured to store the instruction sets depicted in addition to temporarily storing data for the processor 405 to execute various types of routines or functions.

The processor 405 can also be coupled with one or more communication interface(s) 420 and one or more input/output devices 425 via the communications bus 415. The communication interface(s) 420 can comprise, for example, a Bluetooth, WiFi, cellular, and/or other type of wireless communications interface. Via the communication interface(s) 420, the gaming system 105 can communication with a generative AI system 120, gaming venue host systems 125, regulator system 140, and/or other devices and/or systems through a communications network 115 as described above. The input/output devices 425 can include, but are not limited to a display device such as a Liquid Crystal Display (LCD), Light Emitting Diode (LED), Organic Light Emitting Diode (OLED), or other type of display, a ticket printer, etc.

The memory 410 can store therein a set of gaming instructions 430 which, when executed by the processor 405, cause the processor 405 to execute an electronic game. The electronic game can be any of a wide variety of electronic games of chance including, but not limited to, slots, video slots, video poker, keno, blackjack, etc. to be played by a player, e.g., in a casino or other gaming venue. The memory 410 can also store therein a set of content generation instructions 435. Generally speaking, and as introduced above, the content generation instructions 435, when executed by the processor 405, can cause the processor 405 to generate content for an electronic game by generating a game system prompt describing content for the electronic game based on a game prompt data file 110. In some cases, the game prompt can be generated based on information about a player of the electronic game. Such information can be obtained, for example, from the player through the input/output devices 425, from a gaming venue host system 125 through the communications interface(s) 420, or in another way as known in the art. Additionally, or alternatively, the game prompt can be generated based on a set of options defined by an operator of a gaming venue in which the electronic game is installed and stored in the memory 410 of the gaming system 105 or obtained from the gaming venue host system 125 via the communications interface(s) 420. The set of options can identify electronic games to which the game prompt can be applied, game elements of the electronic game to which the game prompt can be applied, a time during which the game prompt can be applied to the electronic game, types of electronic games to which the game prompt can be applied, players for which the game prompt can be applied, and/or conditional logic for applying the game prompt.

The content generation instructions 435 can further cause the processor 405 to receive, from the gaming venue host system 125, via the communications interface(s) 420, an operator prompt describing additional conditions for the content for the electronic game. The additional conditions described by the operator prompt can enforce a brand image for the gaming venue, promote a service of the gaming venue, relate to a player loyalty program for the gaming venue, relate to seasonal content for the electronic game, etc.

The content generation instructions 435 can further cause the processor 405 to receive, from the gaming venue host system 125, via the communications interface(s) 420, a regulator prompt describing additional conditions for the content for the electronic game. The regulator prompt can be provided by a regulator system 140 for a gaming regulator of a geographic area of a gaming venue in which the gaming system is installed. The additional conditions for the content for the electronic game described by the regulator prompt can relate to enforcing gaming regulations, avoiding player confusion, avoiding use of content pre-defined as being prohibited, etc.

The content generation instructions 435 can further cause the processor 405 to generate a final prompt. The final prompt can comprise a combination of the game prompt, operator prompt, and/or the regulator prompt. This combination can comprise, for example, a concatenation or other type of combination. The content generation instructions 435 can further cause the processor 405 to provide the final prompt to a generative AI system 120 via the communications interface(s) 420, receive the content for the electronic game from the generative AI system 120 via the communications interface(s) 420, and apply the received content for the electronic game to the electronic game according to processes as known in the art.

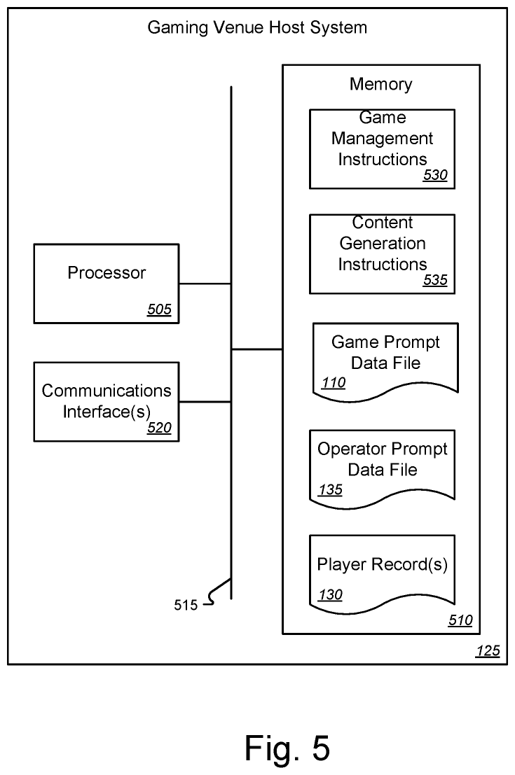

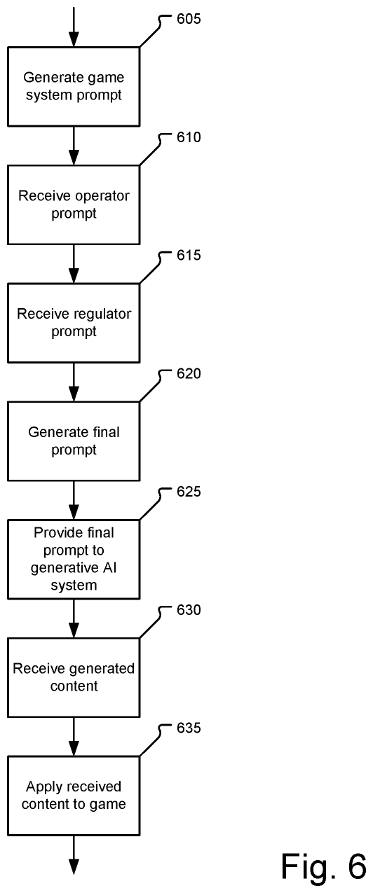

FIG. 5 is a block diagram illustrating additional details of components of an exemplary gaming venue host system according to one embodiment of the present disclosure. As illustrated in this example, a gaming venue host system 125 can comprise a processor 505 such as any of the various types of processors described above. A memory 510 can be coupled with and readable by the processor 505 via a communications bus 515. The memory 510 can comprise any one or more of the different types of volatile and/or non-volatile memories described above. The processor 505 can also be coupled with one or more communication interfaces 520. The communication interface(s) 520 can comprise, for example, a Bluetooth, WiFi, cellular, and/or other type of wireless communications interface(s).

The memory 510 can store therein a set of game management instructions 530 which, when executed by the processor 505, cause the processor 505 to manage one or more gaming systems 105 and/or electronic games executing one the gaming system(s) 105 in various ways a gaming venue as known in the art. The memory 510 can also store therein a set of content generation instructions 535 which, when executed by the processor 505, can cause the processor 505 to generate content for an electronic game or support the gaming system 105 in generating content for the electronic game as described herein. For example, the content generation instructions 535 can cause the processor 505 to generate an operator prompt based on a operator prompt data file 135 and provide the operator prompt to the gaming system 105 through the communications interface(s) 520. In other cases, the content generation instructions 535 can cause the processor 505 to generate a game prompt based on a game prompt data file 110 maintained in the memory 510 of the gaming venue host system 125 and player records 130 maintained in the memory 510 of the gaming venue host system 125 or elsewhere and accessible to the gaming venue host system 125 via the communications interface(s) 520. In such cases, the content generation instructions 535 can further cause the processor 505 to generate an operator prompt based on an operator prompt data file 135, receive a regulator prompt from a regulator system 140, generate a final prompt using the game prompt, operator prompt, and/or regulator prompt as described above, provide the prompt to the generative AI system via the communications interface(s) 520, receive the content for the electronic game from the generative AI system 120 via the communications interface(s) 520, and apply the content to the electronic game, e.g., by providing it to the gaming system 105 through the communications interface(s) 520.

FIG. 6 is a flowchart illustrating an exemplary process for generating content for an electronic game according to one embodiment of the present disclosure. More specifically, this example illustrates processes as may be performed by a gaming system 105 and/or gaming venue host system 125 as described above to generate content for an electronic game based on a set of gaming prompts and one or more of operator prompt(s) and/or regulator prompt(s). As illustrated in this example, generating content for an electronic game can comprise generating 605 a game system prompt describing content for the electronic game. In some cases, the game prompt can be generated based on information about a player of the electronic game. Additionally, or alternatively, the game prompt can be generated based on a set of options defined by an operator of a gaming venue in which the electronic game is installed. The set of options can identify electronic games to which the game prompt can be applied, game elements of the electronic game to which the game prompt can be applied, a time during which the game prompt can be applied to the electronic game, types of electronic games to which the game prompt can be applied, players for which the game prompt can be applied, and/or conditional logic for applying the game prompt.

An operator prompt describing additional conditions for the content for the electronic game can be received 610. The operator prompt can be received 610, for example, from an operator of a gaming venue in which the gaming system is installed. The additional conditions described by the operator prompt can enforce a brand image for the gaming venue, promote a service of the gaming venue, relate to a player loyalty program for the gaming venue, relate to seasonal content for the electronic game, etc.

A regulator prompt describing additional conditions for the content for the electronic game can be received 615. The regulator prompt can be provided by a gaming regulator of a geographic area of a gaming venue in which the gaming system is installed. The additional conditions for the content for the electronic game described by the regulator prompt can relate to enforcing gaming regulations, avoiding player confusion, avoiding use of content pre-defined as being prohibited, etc.

A final prompt can be generated 620. The final prompt can comprise a combination of the game prompt, operator prompt, and/or the regulator prompt. This combination can comprise, for example, a concatenation or other type of combination. The final prompt can be provided 625 to a generative Artificial Intelligence (AI) system and the content for the electronic game can be received 630 from the generative AI system. The received 630 content for the electronic game can then be applied 635 to the electronic game according to processes as known in the art.

A number of variations and modifications of the disclosure can be used. It would be possible to provide for some features of the disclosure without providing others.

The present disclosure contemplates a variety of different gaming systems each having one or more of a plurality of different features, attributes, or characteristics. A “gaming system” as used herein refers to various configurations of: (a) one or more central servers, central controllers, or remote hosts; (b) one or more electronic gaming machines such as those located on a casino floor; and/or (c) one or more personal gaming devices, such as desktop computers, laptop computers, tablet computers or computing devices, personal digital assistants, mobile phones, and other mobile computing devices. Moreover, an EGM as used herein refers to any suitable electronic gaming machine which enables a player to play a game (including but not limited to a game of chance, a game of skill, and/or a game of partial skill) to potentially win one or more awards, wherein the EGM comprises, but is not limited to: a slot machine, a video poker machine, a video lottery terminal, a terminal associated with an electronic table game, a video keno machine, a video bingo machine located on a casino floor, a sports betting terminal, or a kiosk, such as a sports betting kiosk.

In various embodiments, the gaming system of the present disclosure includes: (a) one or more electronic gaming machines in combination with one or more central servers, central controllers, or remote hosts; (b) one or more personal gaming devices in combination with one or more central servers, central controllers, or remote hosts; (c) one or more personal gaming devices in combination with one or more electronic gaming machines; (d) one or more personal gaming devices, one or more electronic gaming machines, and one or more central servers, central controllers, or remote hosts in combination with one another; (e) a single electronic gaming machine; (f) a plurality of electronic gaming machines in combination with one another; (g) a single personal gaming device; (h) a plurality of personal gaming devices in combination with one another; (i) a single central server, central controller, or remote host; and/or (j) a plurality of central servers, central controllers, or remote hosts in combination with one another.

For brevity and clarity and unless specifically stated otherwise, “EGM” as used herein represents one EGM or a plurality of EGMs, “personal gaming device” as used herein represents one personal gaming device or a plurality of personal gaming devices, and “central server, central controller, or remote host” as used herein represents one central server, central controller, or remote host or a plurality of central servers, central controllers, or remote hosts.

As noted above, in various embodiments, the gaming system includes an EGM (or personal gaming device) in combination with a central server, central controller, or remote host. In such embodiments, the EGM (or personal gaming device) is configured to communicate with the central server, central controller, or remote host through a data network or remote communication link. In certain such embodiments, the EGM (or personal gaming device) is configured to communicate with another EGM (or personal gaming device) through the same data network or remote communication link or through a different data network or remote communication link. For example, the gaming system includes a plurality of EGMs that are each configured to communicate with a central server, central controller, or remote host through a data network.

In certain embodiments in which the gaming system includes an EGM (or personal gaming device) in combination with a central server, central controller, or remote host, the central server, central controller, or remote host is any suitable computing device (such as a server) that includes at least one processor and at least one memory device or data storage device. As further described herein, the EGM (or personal gaming device) includes at least one EGM (or personal gaming device) processor configured to transmit and receive data or signals representing events, messages, commands, or any other suitable information between the EGM (or personal gaming device) and the central server, central controller, or remote host. The at least one processor of that EGM (or personal gaming device) is configured to execute the events, messages, or commands represented by such data or signals in conjunction with the operation of the EGM (or personal gaming device). Moreover, the at least one processor of the central server, central controller, or remote host is configured to transmit and receive data or signals representing events, messages, commands, or any other suitable information between the central server, central controller, or remote host and the EGM (or personal gaming device). The at least one processor of the central server, central controller, or remote host is configured to execute the events, messages, or commands represented by such data or signals in conjunction with the operation of the central server, central controller, or remote host. One, more than one, or each of the functions of the central server, central controller, or remote host may be performed by the at least one processor of the EGM (or personal gaming device). Further, one, more than one, or each of the functions of the at least one processor of the EGM (or personal gaming device) may be performed by the at least one processor of the central server, central controller, or remote host.

In certain such embodiments, computerized instructions for controlling any games (such as any primary or base games and/or any secondary or bonus games) displayed by the EGM (or personal gaming device) are executed by the central server, central controller, or remote host. In such “thin client” embodiments, the central server, central controller, or remote host remotely controls any games (or other suitable interfaces) displayed by the EGM (or personal gaming device), and the EGM (or personal gaming device) is utilized to display such games (or suitable interfaces) and to receive one or more inputs or commands. In other such embodiments, computerized instructions for controlling any games displayed by the EGM (or personal gaming device) are communicated from the central server, central controller, or remote host to the EGM (or personal gaming device) and are stored in at least one memory device of the EGM (or personal gaming device). In such “thick client” embodiments, the at least one processor of the EGM (or personal gaming device) executes the computerized instructions to control any games (or other suitable interfaces) displayed by the EGM (or personal gaming device).

In various embodiments in which the gaming system includes a plurality of EGMs (or personal gaming devices), one or more of the EGMs (or personal gaming devices) are thin client EGMs (or personal gaming devices) and one or more of the EGMs (or personal gaming devices) are thick client EGMs (or personal gaming devices). In other embodiments in which the gaming system includes one or more EGMs (or personal gaming devices), certain functions of one or more of the EGMs (or personal gaming devices) are implemented in a thin client environment, and certain other functions of one or more of the EGMs (or personal gaming devices) are implemented in a thick client environment. In one such embodiment in which the gaming system includes an EGM (or personal gaming device) and a central server, central controller, or remote host, computerized instructions for controlling any primary or base games displayed by the EGM (or personal gaming device) are communicated from the central server, central controller, or remote host to the EGM (or personal gaming device) in a thick client configuration, and computerized instructions for controlling any secondary or bonus games or other functions displayed by the EGM (or personal gaming device) are executed by the central server, central controller, or remote host in a thin client configuration.

In certain embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include a local area network (LAN) in which the EGMs (or personal gaming devices) are located substantially proximate to one another and/or the central server, central controller, or remote host. In one example, the EGMs (or personal gaming devices) and the central server, central controller, or remote host are located in a gaming establishment or a portion of a gaming establishment.

In other embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include a wide area network (WAN) in which one or more of the EGMs (or personal gaming devices) are not necessarily located substantially proximate to another one of the EGMs (or personal gaming devices) and/or the central server, central controller, or remote host. For example, one or more of the EGMs (or personal gaming devices) are located: (a) in an area of a gaming establishment different from an area of the gaming establishment in which the central server, central controller, or remote host is located; or (b) in a gaming establishment different from the gaming establishment in which the central server, central controller, or remote host is located. In another example, the central server, central controller, or remote host is not located within a gaming establishment in which the EGMs (or personal gaming devices) are located. In certain embodiments in which the communication network includes a WAN, the gaming system includes a central server, central controller, or remote host and an EGM (or personal gaming device) each located in a different gaming establishment in a same geographic area, such as a same city or a same state. Gaming systems in which the communication network includes a WAN are substantially identical to gaming systems in which the communication network includes a LAN, though the quantity of EGMs (or personal gaming devices) in such gaming systems may vary relative to one another.

In further embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include an internet (such as the Internet) or an intranet. In certain such embodiments, an Internet browser of the EGM (or personal gaming device) is usable to access an Internet game page from any location where an Internet connection is available. In one such embodiment, after the EGM (or personal gaming device) accesses the Internet game page, the central server, central controller, or remote host identifies a player before enabling that player to place any wagers on any plays of any wagering games. In one example, the central server, central controller, or remote host identifies the player by requiring a player account of the player to be logged into via an input of a unique player name and password combination assigned to the player. The central server, central controller, or remote host may, however, identify the player in any other suitable manner, such as by validating a player tracking identification number associated with the player; by reading a player tracking card or other smart card inserted into a card reader; by validating a unique player identification number associated with the player by the central server, central controller, or remote host; or by identifying the EGM (or personal gaming device), such as by identifying the MAC address or the IP address of the Internet facilitator. In various embodiments, once the central server, central controller, or remote host identifies the player, the central server, central controller, or remote host enables placement of one or more wagers on one or more plays of one or more primary or base games and/or one or more secondary or bonus games, and displays those plays via the Internet browser of the EGM (or personal gaming device). Examples of implementations of Internet-based gaming are further described in U.S. Pat. No. 8,764,566, entitled “Internet Remote Game Server,” and U.S. Pat. No. 8,147,334, entitled “Universal Game Server.”

The central server, central controller, or remote host and the EGM (or personal gaming device) are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile Internet network), or any other suitable medium. The expansion in the quantity of computing devices and the quantity and speed of Internet connections in recent years increases opportunities for players to use a variety of EGMs (or personal gaming devices) to play games from an ever-increasing quantity of remote sites. Additionally, the enhanced bandwidth of digital wireless communications may render such technology suitable for some or all communications, particularly if such communications are encrypted. Higher data transmission speeds may be useful for enhancing the sophistication and response of the display and interaction with players.

As should be appreciated by one skilled in the art, aspects of the present disclosure have been illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PUP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure have been described herein with reference to flowchart illustrations and/or block diagrams of methods, apparatuses (systems) and computer program products according to embodiments of the disclosure. It should be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

What is claimed is:

1. A method for generating content for an electronic game, the method comprising:
generating, by a processor of a gaming system, a first prompt describing content for the electronic game;
receiving, by the processor of the gaming system, a second prompt describing additional conditions for the content for the electronic game;
generating, by the processor of the gaming system, a third prompt comprising a combination of the first prompt and the second prompt;
providing, by the processor of the gaming system, the third prompt to a generative Artificial Intelligence (AI) system;
receiving, by the processor of the gaming system, the content for the electronic game from the generative AI system; and
applying, by the processor of the gaming system, the received content for the electronic game to the electronic game.

2. The method of claim 1, wherein the first prompt is generated based on information about a player of the electronic game.

3. The method of claim 1, wherein the first prompt is generated based on a set of options defined by an operator of a gaming venue in which the electronic game is installed.

4. The method of claim 3, wherein the set of options identify electronic games to which the first prompt can be applied.

5. The method of claim 3, wherein the set of options identify game elements of the electronic game to which the first prompt can be applied.

6. The method of claim 3, wherein the set of options identify a time during which the first prompt can be applied to the electronic game.

7. The method of claim 3, wherein the set of options identify types of electronic games to which the first prompt can be applied.

8. The method of claim 3, wherein the set of options identify players for which the first prompt can be applied.

9. The method of claim 3, wherein the set of options define conditional logic for applying the first prompt.

10. A gaming system comprising:
a processor coupled with the communications interface and the input device; and
a memory coupled with and readable by the processor and storing therein a set of instructions which, when executed by the processor, causes the processor to:
generate a first prompt describing content for the electronic game;
receive a second prompt describing additional conditions for the content for the electronic game;
generate a third prompt comprising a combination of the first prompt and the second prompt;
provide the third prompt to a generative Artificial Intelligence (AI) system;
receive the content for the electronic game from the generative AI system; and
apply the received content for the electronic game to the electronic game.

11. The gaming system of claim 10, wherein the second prompt is received from an operator of a gaming venue in which the gaming system is installed.

12. The gaming system of claim 11, wherein the additional conditions described by the second prompt enforce a brand image for the gaming venue.

13. The gaming system of claim 11, wherein the additional conditions described by the second prompt promote a service of the gaming venue.

14. The gaming system of claim 11, wherein the additional conditions described by the second prompt relate to a player loyalty program for the gaming venue.

15. The gaming system of claim 11, wherein the additional conditions described by the second prompt relate to seasonal content for the electronic game.

16. A gaming venue host system comprising:
a processor coupled with the communications interface and the input device; and
a memory coupled with and readable by the processor and storing therein a set of instructions which, when executed by the processor, causes the processor to:
generate a first prompt describing content for an electronic game executed by a gaming system;
receive a second prompt describing additional conditions for the content for the electronic game;
generate a third prompt comprising a combination of the first prompt and the second prompt;
provide the third prompt to a generative Artificial Intelligence (AI) system;
receive the content for the electronic game from the generative AI system; and
apply the received content for the electronic game to the electronic game.

17. The gaming venue host system of claim 16, wherein the second prompt is provided by a gaming regulator of a geographic area of a gaming venue in which the gaming system is installed.

18. The gaming venue host system of claim 17, wherein the additional conditions for the content for the electronic game described by the second prompt relate to enforcing gaming regulations.

19. The gaming venue host system of claim 17, wherein the additional conditions for the content for the electronic game described by the second prompt relate to avoiding player confusion.

20. The gaming venue host system of claim 17, wherein the additional conditions for the content for the electronic game described by the second prompt relate to avoiding use of content pre-defined as being prohibited.
